(19) United States
(12) Patent Application Publication
(10) Pub. No.: US 2006/0177060 A1
(43) Pub. Date: Aug. 10, 2006

(54) Image alignment

(75) Inventors: Mark Thomas Johnson, Eindhoven (NL); Pim Theo Tuyls, Eindhoven (NL); Thomas Andreas Maria Kevenaar, Eindhoven (NL); Geert Jan Schrijen, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 10/565,666

(22) PCT Filed: Jul. 12, 2004
(86) PCT No.: PCT/IB04/51195

§ 371 Date: Jan. 23, 2006

(30) Foreign Application Priority Data
Jul. 21, 2003 (EP) 03102239.5

(51) Int. Cl. H04K 1/00

(52) U.S. Cl. 380/255

(57) ABSTRACT

An image decryption device (1) comprises a screen (10) on which a decrypted image may be visible. The decrypted image may the combination of two partial images, an encrypted image (A) displayed by a display device (2) and a key image or decrypting image (B) superimposed on the encrypted image by the decryption device. To properly align the encrypted image (A) and the key image (B), the decryption device is provided with sensors (11) capable of sensing the position of the decryption device relative to the display device. Corresponding alignment images (22) may be arranged around the screen (20 of the display device, or may be part of the encrypted image. Manual or automatic alignment may be provided.

The present invention relates to the alignment of a display device and a decryption device. More in particular, the present invention relates to a decryption device for decrypting an encrypted image displayed on a screen of a display device, the decryption device comprising a screen on which a decrypted image can be made visible when the decryption device is superimposed on the screen of the display device.

It is well known to encrypt an image in order to prevent the image being recognized or to prevent its contents from being read by unauthorized persons. One technique of encrypting an image is disclosed in, for example, European Patent Application EP 0 260 815. This technique, also known as visual cryptography, employs two patterns, each of which cannot be recognized individually, which are overlaid to produce a recognizable image. To this end, the original image is transformed into two randomized parts or patterns, neither of which contains any perceptible image information. One of these patterns, which may be referred to as the encrypted image, is printed on paper or displayed on a display screen. The other pattern, which may be referred to as the key image, is printed on a transparency or displayed on an at least partially transparent display. When the key image is superimposed on the encrypted image, the patterns are combined in the eye of the viewer and the original image is recognized.

In an alternative technique, the original image is encrypted by permuting its pixels. An example of this technique is described in European Patent Application serial number 02079579.5 (attorney docket PHNL021058). A display device is used which is capable of sensing the pixels of the encrypted image, carrying out an inverse permutation and displaying the resulting decrypted image.

In either technique, a proper alignment of the display device displaying the encrypted image and the decryption device displaying the key image or sensing the encrypted image is important. If the display device and the decryption device are not properly aligned, the “decrypted” image may be unrecognizable.

Above-mentioned European Patent Application EP 0 260 815 acknowledges this problem and provides registration marks. Four registration marks are printed on the sheet showing the encrypted image, surrounding the image. In addition, four registration marks are provided on the transparency carrying the key image. The registration marks of the two substrates have complementary patterns which must be manually overlaid to ensure the proper alignment of the images.

Although this known alignment technique may be suitable for skilled users, it is not self-evident to the user of the transparent display how alignment may be obtained. In addition, the known alignment technique cannot readily be automated.

It is an object of the present invention to overcome these and other problems of the Prior Art and to provide a decryption device which has improved alignment means. In particular, it is an object of the present invention to provide a decryption device which may be capable of assisting the user in aligning its image relative to the display device. Accordingly, the present invention provides a decryption device for decrypting an encrypted image displayed on a screen of a display device, the decryption device comprising a screen on which a decrypted image can be made visible when the decryption device is superimposed on the screen of the display device, wherein the decryption device further comprises sensor means capable of sensing the position of the decryption device relative to the encrypted image.

The sensor means allow electrical or optical sensor signals to be generated. These sensor signals can be used to provide adjustment indications to the user of the decryption device, or to automatically carry out the alignment.

The decryption device of the present invention therefore preferably comprises alignment means for providing alignment signals in response to position signals produced by the sensor means.

Although the decryption device may be capable of only displaying a single image, as in European Patent Application EP 0 260 815 mentioned above, it is preferred that the decryption device is capable of displaying multiple images, in other words, that the decryption device is capable of substituting the image it displays for another image; preferably the decryption device is capable of displaying a plurality of distinct images.

In a first embodiment, the alignment means are arranged for providing visible and/or audible alignment signals so as to assist manual alignment of the decryption device on the one hand and the display device and consequently the encrypted image on the other hand. The alignment signals may be produced by lights bulbs or LEDs (Light Emitting Diodes), or by a small loudspeaker, or both. Alternatively, or additionally, alignment instructions may appear on the screen of the decryption device.

In a second embodiment, the alignment means are arranged for automatic alignment. That is, the alignment means adjust the image on the screen of the decryption device so as to achieve alignment with the (image on the) screen of the display device. This adjustment may be achieved by a translation of the image, that is, by horizontally and/or vertically shifting the image relative to the screen of the decryption device. Alternatively, or additionally, a rotation of the image may be carried out. In an advantageous embodiment, the size and/or the shape of the image may also be adjusted, for example enlarging or shrinking the image, or adjusting for any skew. Accordingly, the decryption device of the present invention may be arranged for adjusting the position and/or the orientation and/or the shape and/or the size of an image displayed on its screen.

The alignment means can therefore be arranged for determining the size of the encrypted image and/or their compatibility, and for compensating any discrepancies. If the encrypted image displayed on the screen of the display device has a different pixel resolution from the key image of the decryption device, the alignment means of the decryption device could be arranged for automatically manipulating the key image so as to best match the encrypted image.

As mentioned above, two types of image decryption devices may be distinguished. A decryption device of the first type has a screen which is at least partially transparent, the decryption device being arranged for displaying a key image on its screen. A decryption device of the second type further comprises a sensor matrix for sensing the encrypted image displayed by the display device, and permuting means for permuting the encrypted image so as to produce a decrypted image which is displayed on its screen. Both types of decryption devices may be arranged in accordance with the present invention.

The sensor means may comprise optical and/or electromagnetic sensors. Preferably, optical sensors are used which sense certain patterns and/or colors on the display device. Optical sensors may be provided with one or more lenses. Said alignment patterns sensed by the alignment sensors may have various designs and may, for example, comprise lines, stripes, concentric circles, varying gray levels, etc. In addition, several patterns located at different points of the display device may co-operate by having certain mutual orientations. The sensor means may, for example, comprise photodiodes and/or charge coupled devices (CCDs). However, as stated above, electromagnetic sensors may also be used, such as sensors detecting the presence of a magnetic field or the presence of a conductive (or non-conductive) element, such as a metal strip.

Additionally, or alternatively, mechanical sensors may be used. Such mechanical sensors may detect variations in the surface of the display device, for example grooves or protrusions. In a very economic embodiment, the mechanical sensors are constituted by corresponding surface parts, for example a groove on the decryption device corresponding with a protrusion on the display device.

The present invention further provides a system for decrypting and displaying encrypted images, the system comprising:
a display device having a screen for displaying an encrypted image, and
a decryption device for decrypting an encrypted image displayed on the screen of a display device,
the decryption device comprising a screen on which a decrypted image can be made visible when the decryption device is superimposed on the screen of the display device, wherein the decryption device further comprises sensor means capable of sensing the position of the decryption device relative to the display device.

To assist the sensor means in sensing the relative position, the display device is preferably provided with alignment images. In a first embodiment, the alignment images are arranged around the screen of the display device. In this embodiment, therefore, the alignment images are arranged on a suitable part of the display device, such as its casing. In a second embodiment, the alignment images are part of the encrypted image. In this embodiment, the alignment images are shown on the screen of the display device. It is of course possible to provide alignment images both on the (casing of the) display device and in the image shown on the screen.

The present invention will further be explained below with reference to exemplary embodiments illustrated in the accompanying drawings, in which:

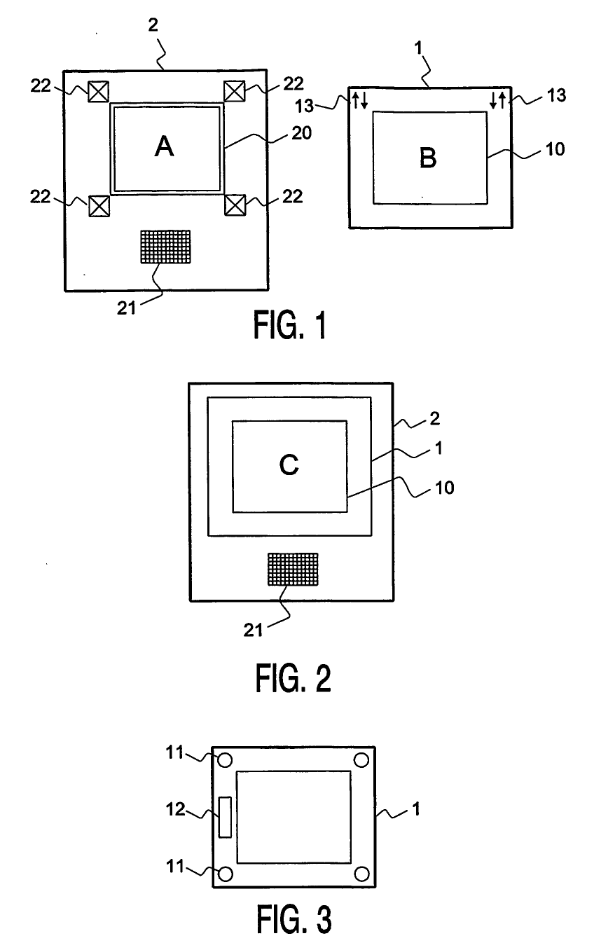

FIG. 1 schematically shows a system comprising a display device and a decryption device according to the present invention.

FIG. 2 schematically shows the system of FIG. 1 with the decryption device placed in front of the screen of the display device.

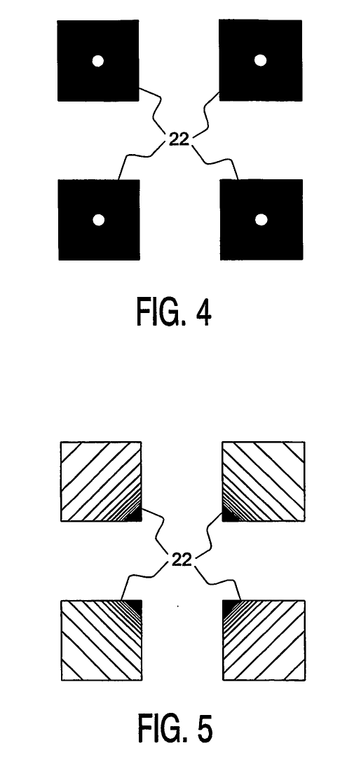

FIG. 3 schematically shows the lower side of the decryption device of FIGS. 1 and 2.

FIG. 4 schematically shows a first set of alignment patterns according to the present invention.

FIG. 5 schematically shows a second set of alignment patterns according to the present invention.

The system shown merely by way of non-limiting example in FIG. 1 comprises a decryption device 1 and a display device 2. The display device 2 may be a dedicated display device for encrypted images or a terminal device, such as a bank terminal (teller machine), or a personal computer, PDA (Personal Digital Assistant), a laptop computer, a mobile telephone or any other device capable of displaying an image. In the system schematically shown in FIG. 1, the display device 2 comprises a screen 20 for displaying an image and a keyboard 21 for entering data. It will be understood that the keyboard is not essential to the present invention. The display device of the present invention further comprises alignment patterns 22 which will be explained later.

The screen 20 of the display device 2 displays an encrypted image A. The actual image, which is not shown in FIG. 1 for the sake of clarity of the illustration, resembles a random pattern, for example one of the type shown in European Patent Application EP 0 260 815 referred to above.

The decryption device 1 comprises a screen 10 which displays a key image B. The key image B also resembles a random pattern. The encrypted image A and the key image B are the two “shares” or partial images derived from a single, original image. Superimposing these “shares”, that is, the encrypted image A and the key image B, will result in a decrypted image C which will resemble the original image. Accordingly, as shown in FIG. 2, the decryption device 1 is placed against the display device 2 such that the screen 10 of the decryption device covers the screen 20 of the display device 2. As the screen 10 is at least partially transparent, a user will be able to see both image A and image B, together resulting in a recognizable image C.

The decryption device 1 is a trusted device which may be used together with a non-trusted display device. Preferably there is no electrical connection between the display device 2 and the decryption device 1 so as the preserve the security of the decryption device.

It will be understood that a correct alignment of the images A and B is required in order to produce a recognizable image C. A correct alignment of the images is achieved when the screens 10 and 20 are properly aligned. In accordance with the present invention, the lower side (also referred to as back side) of the decryption device 10 is provided with sensor units 11, as shown in the example of FIG. 3 (the lower side is understood to be the side facing the display device 2 when the decryption device 1 is being used). These sensor units 11 may each comprise a single sensor or a plurality of sensors such as sensor array, The sensor units 11 are positioned such that, in use, their positions approximately coincide with those of the alignment patterns 22 on the display device 2. The decryption device 1 may further comprise alignment means 12, shown in FIG. 3 to be mounted on the lower side of the decryption device. However, the alignment means 12 may advantageously be accommodated inside the decryption device. The alignment means 12 may be constituted by a microprocessor and an associated memory, the microprocessor being capable of producing appropriate alignment signals in response to sensor signals received from the sensor units 11.

The alignment signals may result in visual and/or aural indication being given to the user of the decryption device. In FIG. 1 exemplary indications 13 are shown which may light up in response to alignment signals produced by the alignment means. In this way, the user can be instructed to lift one corner of the device while lowering another corner. The indications 13 may comprise LEDs or other suitable light producing elements. In addition to, or instead of the visual indications, sound signals may be produced, for example higher and lower sounds suggesting the raising or the lowering of the device, or voice instructions. Alternatively, suitable instructions may appear in the image B.

The sensors 11 shown in FIG. 3 are preferably optical sensors capable of producing an electrical signal in response to incident light. Suitable types of sensors are, for example, sensors based upon CCDs (Charge Coupled Devices) or photo-diodes. Such sensors effectively measure the darkness of the alignment patterns 22 at a certain point and produce a corresponding sensor signal. Alternatively, electromagnetic sensors may be used, and the alignment patterns 22 (FIG. 1) may, for example, be replaced with magnets or conductive strips. In a further embodiment, mechanical sensors involving, for example, co-operating pairs of protrusions and grooves may be used, in addition to or instead of the optical or electromagnetic sensors mentioned above.

In a preferred embodiment, optical sensors are used, as mentioned above. In such an embodiment, alignment patterns 22 will be used. Examples of alignment patterns are shown in FIGS. 4 and 5. In the embodiment of FIG. 4, the alignment patterns are essentially black, having a white dot in the middle. It will be clear that the white dot indicates a reference location, and that an optical sensor may produce a stronger sensor signal when detecting the white dot than when detecting the surrounding black area. When a sensor array (matrix) is used, the sensor detecting the white dot will produce a sensor signal whereas the other sensors of the array will not, thus indicating the (relative) position of the white dot.

In a particularly advantageous embodiment the decryption device 1 is arranged for automatically aligning its image B in response to the alignment signals. On the basis of the sensor signals, the (alignment means of the) decryption device can determine if and to what extent the image B on the decryption device is to be scaled, translated, rotated, skewed and/or otherwise transformed so as to align the key image B with the encrypted image A.

For example, when the decryption device comprises a matrix display, translating the image may be achieved by shifting the image data by an integral number of pixel rows and/or columns. To scale and/or rotate the image, the position of the pixels on the display may first be processed in accordance with a desired geometrical mapping before displaying the image again with the desired size and/or orientation. The key image is preferably designed such that translating, rotating or scaling the image is possible without loss of image information. This can be facilitated by ensuring that only part of the key image and the encrypted image contains information, said part preferably be located near or towards the center of the image. In a preferred embodiment, the actual image is centered on the screen, leaving a border on all sides. Such a border which is left for adjustment purposes may have a width ranging from 1% to 40% of the respective screen dimension, but a width of approximately 10% is preferred, although other widths may also be used.

In FIG. 5, the alignment patterns consist of stripes having a spacing which decreases in the direction of the encrypted image. All four patterns 22 are rotated 90° relative to each other, thus together providing both location and direction information. Sensor signals will relate to either the line spacing or the average brightness level, or both, and the combined signals from several (for example three or four) sensor units 11 will provide an indication of image misalignment, which in turn will enable corrective image manipulations as set out above.

It will be understood that instead of the patterns shown in FIGS. 4 and 5 various other patterns can also be used, for example patterns containing crossing lines as shown in FIG. 1. Instead of straight lines, curved lines can be used, for example concentric semi-circles. The patterns may also have a varying gray level, or may utilize various colors.

In the embodiment shown in FIG. 1 the alignment patterns 22 are arranged around the screen 20. It will be understood that such an arrangement of four alignment patterns is given by way of example only and that other arrangements are possible. For instance, less than four alignment patterns could be used, for example three patterns. Also, the alignment patterns need not surround the screen 20 but could all be located on one side of the screen. In an advantageous embodiment, the alignment patterns are not provided on the casing of the display device 2 but are shown on the screen 20, as part of the image A. The display device 2 may have a special alignment pattern generator for this purpose.

As mentioned above, the present invention may be advantageously utilized in various applications where encrypted images have to be decrypted, such as teller machines and payment terminals.

It is noted that in the above discussion of FIGS. 1-5 it was assumed that the screen 10 of the decryption device 1 is transparent. This is, however, not essential and embodiments can be envisaged in which the lower side of the decryption device is provided with image sensors for sensing the encrypted image and permuting the encrypted image so as to produce a decrypted image which is then displayed on the non-transparent display.

The present invention is based upon the insight that a proper alignment of a display device and a superimposed image decryption device can be facilitated by providing sensors capable of sensing or detecting the position of the decryption device relative to the display device. The present invention benefits from the further insight that sensors producing alignment signals can advantageously be used to give alignment instructions to the user or to automate the alignment process.

It is noted that any terms used in this document should not be construed so as limit the scope of the present invention. In particular, the words “comprise(s)” and “comprising” are not meant to exclude any elements not specifically stated. Single (circuit) elements may be substituted with multiple (circuit) elements or with their equivalents. Any reference signs in the claims should of course not be construed so as to limit the scope of the claims.

It will be understood by those skilled in the art that the present invention is not limited to the embodiments illustrated above and that many modifications and additions may be made without departing from the scope of the invention as defined in the appending claims.

1. A decryption device (1) for decrypting an encrypted image (A) displayed on a screen (20) of a display device (2), the decryption device comprising a screen (10) on which a decrypted image (C) can be made visible when the decryption device (1) is superimposed on the screen (20) of the display device, wherein the decryption device further comprises sensor means (11) capable of sensing the position of the decryption device relative to the encrypted image (A).

2. The decryption device according to claim 1, further capable of displaying multiple images.

3. The decryption device according to claim 1 or 2, further comprising alignment means (12) for providing alignment signals in response to position signals produced by the sensor means (11).

4. The decryption device according to claim 3, wherein the alignment means (12) are arranged for providing visible and/or audible alignment signals so as to assist manual alignment of the decryption device and the display device.

5. The decryption device according to claim 3 or 4, wherein the alignment means (12) are arranged for automatic alignment.

6. The decryption device according to claim 5, further arranged for adjusting the position and/or the orientation and/or the size and/or the skew of an image (B) displayed on its screen (10).

7. The decryption device according to any of the preceding claims, wherein only part of the screen (10, 20) contains an image, said part preferably being located towards the center of the respective screen.

8. The decryption device according to any of the preceding claims, wherein its screen (10) is at least partially transparent, the decryption device being arranged for displaying a key image (B) on its screen.

9. The decryption device according to any of the preceding claims, further comprising a sensor matrix for sensing the encrypted image displayed by the display device, and permuting means for permuting the encrypted image (B) so as to produce a decrypted image (C) which is displayed on its screen (10).

10. The decryption device according to any of the preceding claims, wherein the sensor means (11) comprise optical and/or electromagnetic sensors.

11. The decryption device according to claim 10, wherein the sensor means (11) comprise photodiodes and/or charge coupled devices (CCDs).

12. The decryption device according to any of the preceding claims, wherein the sensor means (11) comprise mechanical sensors.

13. A system for decrypting and displaying encrypted images, the system comprising:
a display device (2) having a screen (20) for displaying an encrypted image (A), and
a decryption device (1) for decrypting an encrypted image (A) displayed on the screen (20) of a display device (2),
the decryption device comprising a screen (10) on which a decrypted image (C) can be made visible when the decryption device (1) is superimposed on the screen (20) of the display device, wherein the decryption device further comprises sensor means (11) capable of sensing the position of the decryption device relative to the display device.

14. The system according to claim 13, wherein the decryption device (1) is capable of displaying multiple images.

15. The system according to claim 13 or 14, wherein the display device (2) is provided with alignment images (22).

16. The system according to claim 15, wherein the alignment images (22) are arranged around the screen (20) of the display device.

17. The system according to claim 15, wherein the alignment images (22) are part of the encrypted image (A).
